(19) United States
(12) Patent Application Publication
(10) Pub. No.: US 2018/0137559 A1
(43) Pub. Date: May 17, 2018

(54) VIRTUAL REALITY SHOPPING DEVICE

(71) Applicants: Junichi MIMURA, Tokyo (JP); Sumiyo MIMURA, Tokyo (JP); Yuki MIMURA, Tokyo (JP); Ryo MIMURA, Tokyo (JP)

(72) Inventors: Junichi MIMURA, Tokyo (JP); Sumiyo MIMURA, Tokyo (JP); Yuki MIMURA, Tokyo (JP); Ryo MIMURA, Tokyo (JP)

(21) Appl. No.: 15/351,448

(22) Filed: Nov. 15, 2016

(51) Int. Cl. G06Q 30/06; G06T 3/40; G09G 5/00

(52) U.S. Cl. CPC G06Q 30/0643; G06T 19/006; G09G 5/003; G06T 3/40

(57) ABSTRACT

A virtual reality shopping device includes a virtual reality glass having a slit for reading the credit card information, a telecommunication circuit device for receiving shop information data, the shop information data including product images to be sold and interior images of the shop, an image screen mounted on the glass on which the product images and the interior images are projected, and a controller, which is connected to the glass.

### BACKGROUND OF THE INVENTION

### 1. Field of the Invention

The invention relates to a virtual reality shopping device and specifically, relates to a device creating a shopping center in a virtual space so that the shopper, especially elder person, can purchase items placed in the shopping center in a virtual space by watching them without actually going to there.

### 2. Description of the Related Art

There were many ways for shopping at the supermarket, such as Safeway or Giant. One of them is that the shopper goes there actually. Another is that the shopper uses the shopping site on internet, which is provided by each supermarket. In the former case, since the shopper actually goer to the supermarket, and actually pays for the items, his “Purchase instinct” which means an appetite that a person want to buy something, will be satisfied. However, it may not be easy for an elder person having difficulty in moving his legs to go to the supermarket. Moreover, there are many persons who are difficult to go outside because of the mental illness. Further, considering the different view, in the case that the people living in the suburban area in which there are not so many supermarket, go to the supermarket individually, they will spend a lot of fuel or gasoline as a whole view.

For such occasions, the latter case may be considered. In the latter case, it may be possible that the deliveryman hired by the supermarket can deliver the items for the plurality of homes, which are located in the close area, simultaneously. In fact, Amazon performs this kinds of service.

However, it is difficult for shopper to realize the size or the freshness of the items because the shopper purchase the item by watching the on-line pictures which have been taken long ago, and because the actual size may be realized by touching the item, not by figure, such as 1″×3″. Moreover, in case of the conventional net shopping, the purchase instinct may not be completely satisfied because the shopper does not actually go to the supermarket.

According to a virtual reality shopping device of the invention, the potential shopper using this device purchases the item as if he is actually in the supermarket without going there.

### SUMMARY OF THE INVENTION

An objective of the invention is to solve the above-described problem and to provide a virtual reality shopping device as if the user actually goes to shopping without going to the shop.

The objective is achieved by a virtual reality shopping device having a virtual reality glass which includes a slit for reading the credit card information, a telecommunication circuit device for receiving shop information data, the shop information data including product images to be sold and interior images of the shop, an image screen mounted on the glass on which the product images and the interior images are projected, and a controller, which is connected to the glass.

### BRIEF DESCRIPTION OF THE DRAWINGS

The invention will be more particularly described with reference to the accompanying drawings, in which:

FIG. 1A show a perspective view of a head-mount type virtual reality shopping device, according to a preferred embodiment;

FIG. 1B shows a perspective view of a controller of the head-mount type virtual reality shopping device shown in FIG. 1A; and

FIG. 2A-2E shows a seize of images projected on a screen of the head-mount type virtual reality shopping device.

### DETAILED DESCRIPTION OF THE PREFERRED EMBODIMENTS

The preferred embodiment of the invention as to a virtual reality shopping device is explained together with drawings as follows. In each drawing, the same reference numbers designate the same or similar components through all embodiments.

### THE PREFERRED EMBODIMENT

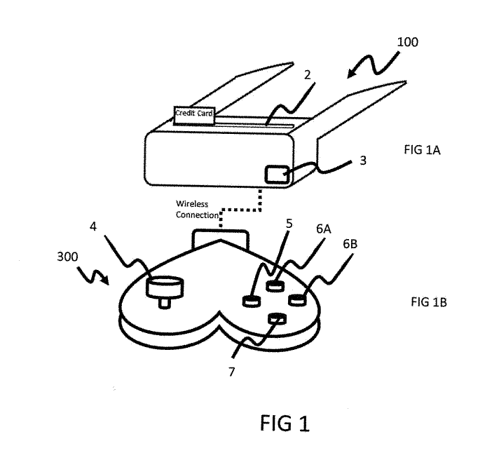

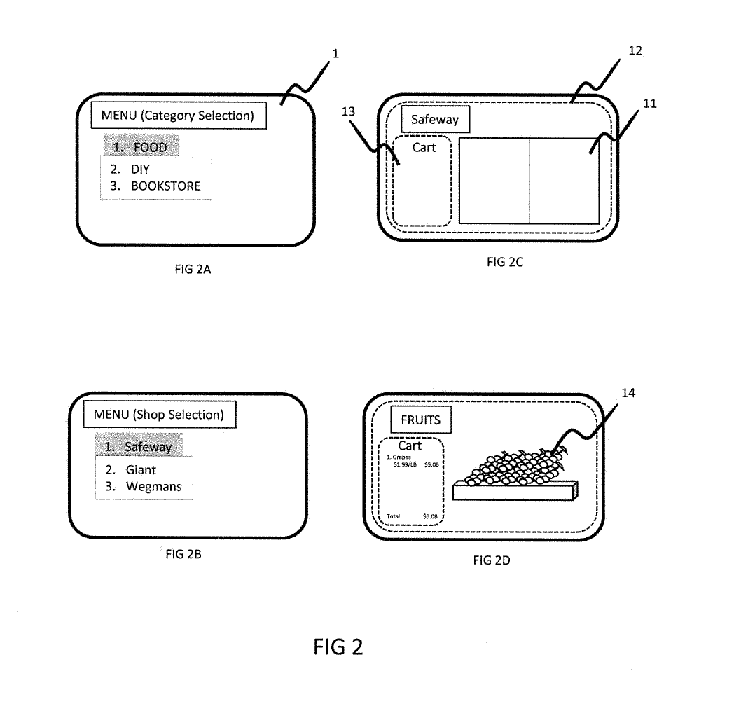

FIG. 1A show the perspective view of a head-mount type virtual reality glass (hereinafter it is simply called as “HMVR”) 100 of the invention. The HMVR 100 can display images and movies on a screen 1 by using the technology shown in the US2015/0348327A1. According to the HMVR 100, the user of this device can feel as if he would actually be there. The HMVR 100 includes a slit 2 for reading credit card information. An unillustrated credit card reader is located in the slit 2. The information can be stored in a memory located in the HMVR 100. The HMVR 100 includes a telecommunication circuit device 3, which can be connected by a WIFI or a telephone line so that the operating information or the credit card data from the HMVR 100 can be transmitted through the internet.

A controller 200, which is paired and connected to the HMVR 100 wirelessly, includes an operation button 4 for walking virtually in the screen image projected in the HMVR 100, a product selection button 5 for picking up or dropping off a product in the screen image projected in the HMVR 100, a zoom-in button 6A for watching the fine detail of the product, a zoom-out button 6B for putting the product image to the original state, and a cart button 7 for adding the product into a virtual shopping cart. The cart button 7 may have another function for selecting menu, like “OK Button”. In order to improve the operability, the operation button 4 is arranged in the left side of the controller 200, and the other buttons 5, 6A, 6B, 7 are arranged in the right side. It is possible to switch the above mentioned layout for left-hander operation.

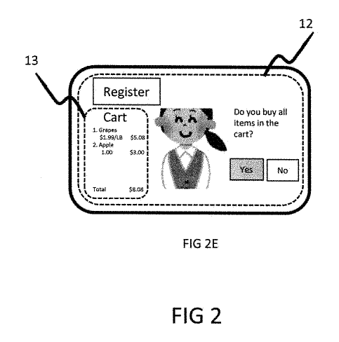

An operation for using of the HMVR 100 and the controller 200 are explained in accordance with FIG. 2. FIG. 2A through FIG. 2E are a series of the screen images projected on the screen 1 of the HMVR 100. As shown in FIG. 1, the preparation for shopping is completed by simply powering the HMVR 100 on and by swiping a credit card in the slit 2. Once the user swipes the credit card, it is not necessary to swipe it again.

After swiping the credit card, a menu shown in FIG. 2A is projected on the screen 1. In the menu image, such as “MENU (Category Selection) shown in FIG. 2A, the user can selects the category for shopping. In FIG. 2A, “Food”, “Do-it-yourself store” and “Bookstore” are displayed, for example. The user selects one of the menu for shopping. For a default setting, “Food” is selected, and if the user goes shopping for food, he can simply press the cart button 7. If the user wants to go shopping in the bookstore, he can hit down the operation button 4 twice so the shade on the letters in the screen 1 is moved on the “Bookstore”. In this embodiment, the “Food” is selected.

After selecting the category, “MENU (Shop Selection) is projected on the screen 1 as shown in FIG. 2B. The user can select a favorite supermarket. If the user wants to go shopping at “Safeway”, he simply presses the cart button 7. If the user wants to go shopping at the different supermarket, it is possible to do so by operating the operation button 4 as described above. In this embodiment, “Safeway” is selected.

Next, when “Safeway” is selected, the screen image on the screen is divided into two, one is main screen window 12, and another is sub screen window 13, as shown in FIG. 2C. In the main screen window 12, the selected supermarket, namely “Safeway” is projected on the top, and an entrance image 11 of “Safeway” is projected. In the sub screen window 13, a cart information is projected. Under this state, since the user buy nothing yet, the car is empty. The user moves the operation button 4 forward, the projected image is moving forward as if the user actually walks so that the user feels that he actually walks toward “Safeway”. When the user reaches in front of the entrance 11, the user can walk in “Safeway” virtually by opening the entrance 11.

Generally, the supermarket is divided into several sections, such as a fruit section, a vegetable section, a snack section and so on. In the FIG. 2D, the user stepped into the fruit section. Then, the word “Safeway” is automatically changed to “FRUITS” at the top of the main window 12, and the user can watch the fruits 14. The fruits information, such as images or movies of the products, is sent to the unillustrated cloud storage from “Safeway” every morning, and when new fruits 14 are displayed in the actual store, the new fruits information is also sent to the cloud storage timely. The user of this device receives the updated product information from the cloud storage. Thus, the fruits 14 in the screen 1 shown in the FIG. 2D may vary from season to season. When the user approaches the fruits 14 by operating the operation button 4, and presses the product selection button 5, then he can watch the movie showing that the fruits 14 are being picked. If the user wants to watch the fine detail of the fruits 14, he needs to press the zoom-in button 6A. Since the product information is timely received, the user can watch the actual condition of the product, such as color or size. When the user rotates the operation button 4, the screen image of the fruits 14 is rotated so he can watch it with a 360-degree field of vision. When the user presses the zoom-out button 6B, the screen image is returned to the state that the fruits are picked. In another embodiment, it is possible that the zoom-up function is effective during the period for pressing the zoom-in button 6A, and the zoom-up function is terminated when the zoom-in button 6A is released. In this case, it is not necessary to provide the zoom-out button 6B.

If the user wants to buy the product, he presses the cart button 7 so that the product is placed in the virtual cart. Once the product is placed in the cart, the product name, the price for one piece or for pound, and total cost is displayed in the cart image in the sub screen window 13. Since the HMVR 100 receives actual image data from “Safeway”, the user feels as if he actually walks in “Safeway” by operating the operation button 4. Further, if the user turn his head from side to side, he can see the entire area in “Safeway”.

In order to complete the shopping, the user needs to go to the cash register in virtual world by operating the operation button 4. It is possible to let the user go to the cash register by pressing the operation button 4 if the operation button 4 has such a function. In this case, it may have the advantage of increased speed. FIG. 2E shows the screen image in front of the cash register. In FIG. 2E, “Register” is displayed at the top of the main screen window 12. Before checking out, since the HMVR 100 asks the final question to the user, such as “Do you buy all items in the cart?”, he can chose one of icons that is “Yes” or “No” by watching the products in the cart displayed in the sub screen window 13. If the user selects “No” icon, then it is possible to delete all or a part of the products in the cart.

When the user decides to buy the products in the cart, he selects “Yes” icon, and presses the cart button 7. Herewith, the information for shopping and the credit card data are sent to “Safeway”, which is located nearest to the user. Generally, the credit card data includes the billing address so that “Safeway” can easily identify the particular “Safeway”, which is located nearest to the user. After the nearest “Safeway” receives such information, it delivers the products. There are some way to increase the delivering efficiency. If the user is not in rush to receive the product, “Safeway” can wait another delivering request in the same delivery area. The user is in rush to receive the product, a rush service icon can be projected on the screen, and “Safeway” may extra-charge for that service.

According to the preferred embodiment, it is possible to satisfy the “Purchase instinct” for an elder person who has difficulty in moving his legs to go to the supermarket or for a person who is difficult to go outside because of the mental illness.

While the invention has been described with reference to illustrative embodiments, this description is not intended to be construed in a limiting sense. Thus, shapes, size and physical relationship of each component are roughly illustrated so the scope of the invention should not be construed to be limited to them. Further, to clarify the components of the invention, hatching is partially omitted in the cross-sectional views. Moreover, the numerical description in the embodiment described above is one of the preferred examples in the preferred embodiment so that the scope of the invention should not be construed to limit to them.

Various other modifications of the illustrated embodiment will be apparent to those skilled in the art on reference to this description. Therefore, the appended claims are intended to cover any such modifications or embodiments as fall within the true scope of the invention.

What I claim is:

1. A virtual reality shopping device having a virtual reality glass, the virtual reality glass comprising:
a slit for reading the credit card information,
a telecommunication circuit device for receiving shop information data, the shop information data including product images to be sold and interior images of the shop,
an image screen mounted on the glass on which the product images and the interior images are projected, and
a controller, which is connected to the glass.

2. A virtual reality shopping device having a virtual reality glass as claimed in claim 1, wherein the controller include the operation button for walking virtually in the screen image projected, a product selection button 5 for picking up or dropping off a product in the screen image projected, a zoom-in button 6A for watching the fine detail of the product, a zoom-out button 6B for putting the product image to the original state, and a cart button 7 for adding the product into a virtual shopping cart.

3. A virtual reality shopping device having a virtual reality glass as claimed in claim 1, wherein the controller is connected to the glass wirelessly.

4. A virtual reality shopping device having a virtual reality glass as claimed in claim 1, wherein the telecommunication circuit device receives the data every day and wherein the data is updated timely, thereby the product to be projected vary from season to season.
